(19) United States
(12) Patent Application Publication
(10) Pub. No.: US 2010/0302288 A1
(43) Pub. Date: Dec. 2, 2010

(54) DUAL ENDED DRIVER CIRCUIT FOR LCD BACKLIGHT AND THE METHOD THEREOF

(76) Inventors: Yuancheng Ren, Hangzhou (CN); Jiali Cai, Hangzhou (CN); Lei Du, Hangzhou (CN); Junming Zhang, Hangzhou (CN); Eric Yang, Saratoga, CA (US)

Correspondence Address: PERKINS COIE LLP;PATENT-SEA, P.O. BOX 1247, SEATTLE, WA, 98111-1247, US

(21) Appl. No.: 12/787,974

(22) Filed: May 26, 2010

(30) Foreign Application Priority Data
May 26, 2009 (CN) 200910059430.X

(51) Int. Cl. G09G 5/10

(52) U.S. Cl. 345/690; 345/102

(57) ABSTRACT

A dual ended driver circuit for a LCD backlight is disclosed. The circuit comprises a master board and a slave board, which provides a first output drive signal and a second output drive signal to either end of a lamp set, respectively. The circuit only uses one control chip to synchronize and make symmetrical the first output drive signal and the second output drive signal.

### CROSS-REFERENCE TO RELATED APPLICATIONS

This application claims priority to and the benefit of Chinese Patent Application No. 200910059430.X, filed May 26, 2009, which is incorporated herein by reference in its entirety.

### TECHNICAL FIELD

This disclosure relates generally to a driver circuit for a LCD backlight, and more particularly, to a dual ended driver circuit for a LCD backlight.

### BACKGROUND

Lamps in large LCD panel backlight applications are very long. In order to get high luminance uniformity, the lamps are driven at both ends (referred to also as dual ended driven). To maximize the life of the lamps, the lamps need to be driven by pure sine waveforms at both ends. Any DC component or harmonic would cause some of the gases to accumulate at one end of the tube and create an irreversible light gradient, so that one end of the tube is brighter than the other, which will significantly shorten the lamp life. In addition, to maximize the efficiency, the drive signals for the dual ends should be 180° phase shifted. The synchronization and symmetry of the drive signals is important. Any mismatch will influence reliability and efficiency.

FIG. 1 is a prior art dual ended driver circuit 50 for a LCD backlight. As shown in FIG. 1, circuit 50 comprises a master board B₁ for providing a drive signal to one end of a lamp set, and a slave board B₂ for providing a drive signal to the other end of the lamp set. The lamp set comprises N lamps coupled in parallel, wherein N is an integer number. The master board B₁ includes a control chip IC₁, while the slave board B₂ includes a control chip IC₂. The control chip IC₁ at the master board B₁ delivers the synchronous signal S_{Y} to the control chip IC₂ at the slave board B₂, so as to synchronization the drive signals provided by the two boards. The master board B₁ further comprises a first output stage circuit O₁ which receives the output signal of the control chip IC₁ and a first transformer set T₁ which receives the output signal of the first output stage O₁. The slave board B₂ further comprises a second output stage circuit O₂ which receives the output signal of the control chip IC₂ and a second transformer set T₂ which receives the output signal of the second output stage O₂.

The first output stage circuit O₁ and the second output stage circuit O₂ may comprise one or more output stages. The topology of the output stage may be full-bridge, half-bridge, or push-pull.

The output signals provided by the first transformer set T₁ and the second transformer T₂ are drive signals used to drive the two ends of the lamp set, so as to provide backlight to the LCD panel. In addition, the first transformer set T₁ provides a lamp feedback signal FB₁ to the control chip IC₁ and the second transformer set T₂ provides a lamp feedback signal FB₂ to the control chip IC₂.

As illustrated above, circuit 50 uses two control chips to drive the lamp set. It synchronizes the drive signals through the synchronous signal S_{Y}. However, the synchronous signal S_{Y} is sensitive and easily corrupted. Thus, the drive signals at either end may not have good symmetry. In addition, the duty cycle and frequency may differ at the two ends due to different control ICs with different lamp feedback signals.

### BRIEF DESCRIPTION OF THE DRAWINGS

FIG. 1 illustrates a prior art dual ended driver circuit 50 for a LCD backlight.

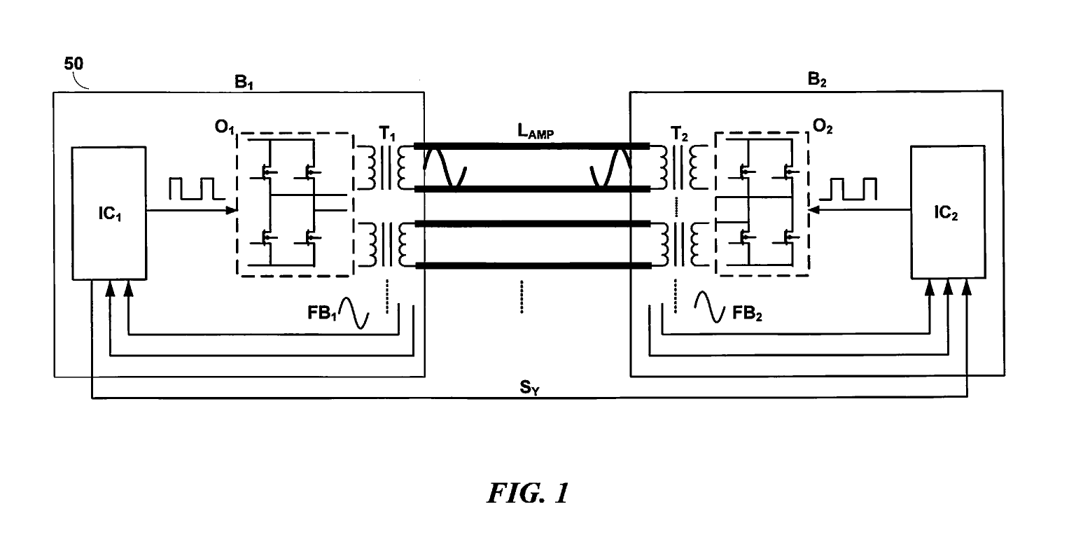

FIG. 2 illustrates a dual ended driver circuit 100 which uses only one control chip in accordance with an embodiment of the present invention.

FIG. 3 illustrates a dual ended driver circuit 200 which uses only one control chip in accordance with another embodiment of the present invention.

### DETAILED DESCRIPTION

In the description that follows, the scope of the term “an embodiment” is not to be limited as to mean more than one embodiment, bur rather, the scope may include one embodiment, more than one embodiment, or perhaps all embodiments.

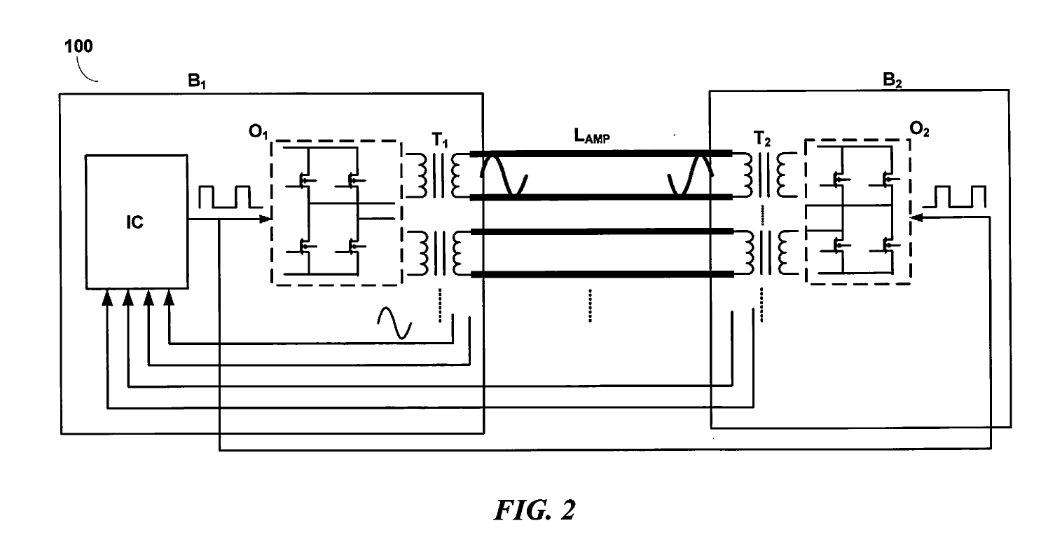

FIG. 2 illustrates a dual ended driver circuit 100 which uses only one control chip in accordance with an embodiment of the present invention. In contrast to prior art circuit 50, circuit 100 adopts a control chip IC to provide a control signal to the master board B₁ and the slave board B₂. In other words, the single control chip IC in circuit 100 replaces the two control chips IC₁ and IC₂ in circuit 50. In this embodiment, the control chip IC is placed in the master board B₁, for receiving lamp feedback signals which represent the voltage, current or power status of the lamp set, and providing signals thereupon.

Specifically, circuit 100 comprises the master board B₁ and the slave board B₂. The master board B₁ is coupled to one end of a lamp set to provide a first drive signal. The slave board B₂ is coupled to the other end of the lamp set to provide a second drive signal. The master board B₁ further comprises a first output stage circuit O₁, for receiving the control signal and providing a first amplified signal, and a first transformer set T₁, coupled to the first output stage circuit O₁, for receiving the first amplified signal and providing a first output driven signal. The slave board B₂ comprises a second output stage circuit O₂, for receiving the control signal and providing a second amplified signal and a second transformer set T₂, coupled to the second output stage circuit O₂, for receiving the second amplified signal and providing a second output driven signal. The first output driven signal provided by the first transformer set T₁ is the first driven signal, which is sent to the first end of the lamp set. The second output driven signal provided by the second transformer set T₂ is the second driven signal, which is sent to the second end of the lamp set.

In one embodiment, the first output stage circuit O₁ and the second output stage circuit O₂ comprises one or more output stages, which could be full-bridge, half-bridge, and push-pull.

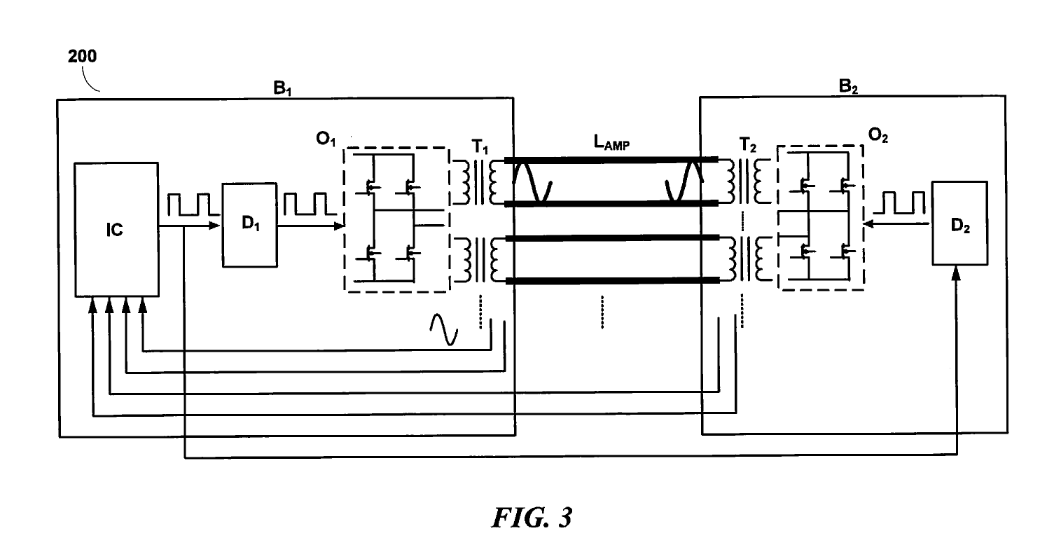

FIG. 3 illustrates a dual ended driver circuit 200 which uses only one control chip in accordance with another embodiment of the present invention. In contrast to circuit 100, there is a first drive circuit D₁ in the master board B₁ and a second drive circuit D₂ in the slave board in circuit 200, while the driver circuit of circuit 100 is integrated into the control chip IC. One skilled in the art should realize that, compared to circuit 100, the slave board B₂ in circuit 200 has a higher drive ability.

In one embodiment, the first driven circuit D₁ in the master board B₁ of circuit 200 is integrated into the control chip IC. In addition, the first driven circuit D₁ and the second driven circuit D₂ comprise one or more drivers.

When circuit 200 is on operation, the first drive circuit D₁ receives the control signal provided by the control chip IC, and outputs the first switch driven signal. The first output stage circuit O₁ receives the first switch drive signal, and provides a first amplified signal. The first transformer set T₁ receives the first amplified signal, and provides a first output drive signal to one end of the lamp set.

In the slave board B₂, the second drive circuit D₂ receives the control signal provided by the control chip IC, and outputs the second switch drive signal. The second output stage circuit O₂ receives the second switch drive signal, and provides a second amplified signal. The second transformer set T₂ receives the second amplified signal, and provides a second output drive signal to the other end of the lamp set.

As illustrated above, circuit 100/200 drives the lamp set to provide backlight to the LCD by adopting only a single control chip. Accordingly, no synchronous signal is needed. In addition, the output signals of the first transformer set T₁ and the second transformer set T₂ are fed back to the control chip IC, so as to get the output drive signals modulated. The 180° phase shift could be realized by accurately controlling the ON/OFF of switches in the first output stage circuit O₁ and the second output stage circuit O₂, or by setting the dotted terminals of the first transformer set T₁ and the second transformer set T₂. The control signal could also be set to realize the 180° phase shift. As a result, the synchronization and the symmetry of the driven signals are realized.

This written description uses examples to disclose the invention, including the best mode, and also to enable a person skilled in the art to make and use the invention. The patentable scope of the invention may include other examples that occur to those skilled in the art.

I/We claim:

1. A dual ended driver circuit for a LCD backlight comprising:
a master board, for providing a first output drive signal to one end of a lamp set;
a slave board, for providing a second output drive signal to the other end of the lamp set,
wherein the master board comprises a control chip, for providing a control signal to the master board and the slave board in respond to a feedback signal of the lamp set, such that the first output drive signal and the second output drive signal are synchronous and symmetrical.

2. The dual ended driver circuit of claim 1, wherein the master board further comprises:
a first drive circuit, coupled to the control chip, for providing a first switch drive signal in response to the control signal;
a first output stage circuit, for providing a first amplified signal in respond to the first switch drive signal; and
a first transformer set, for providing the first output drive signal in response to the first amplified signal.

3. The dual ended driver circuit of claim 2, wherein the slave board further comprises:
a second drive circuit, coupled to the control chip, for providing a second switch drive signal in response to the control signal;
a second output stage circuit, for providing a second amplified signal in response to the second switch drive signal; and
a second transformer set, for providing the second output drive signal in response to the second amplified signal.

4. The dual ended driver circuit of claim 1, wherein the master board further comprises:
a first output stage circuit, coupled to the control chip, for providing a first amplified signal in response to the control signal; and
a first transformer set, for providing the first output drive signal in response to the first amplified signal.

5. The dual ended driver circuit of claim 4, wherein the slave board further comprises:
a second output stage circuit, coupled to the control chip, for providing a second amplified signal in response to the control signal; and
a second transformer set, for providing the second output drive signal in response to the second amplified signal.

6. The dual ended driver circuit of claim 3, wherein the first output stage circuit and the second output stage circuit comprise at least one output stage.

7. The dual ended driver circuit of claim 5, wherein the first output stage circuit and the second output stage circuit comprise at least one output stage.

8. The dual ended driver circuit of claim 1, wherein the feedback signal is a current signal, or a voltage signal, or a power signal.

9. A dual ended driver method for a LCD backlight comprising:
providing a first output drive signal to one end of a lamp set; and
providing a second output drive signal to the other end of the lamp set,
wherein the first output drive signal and the second output drive signal are made to be synchronized and symmetrical by a control signal provided by a control chip.

10. The dual ended driver method of claim 9, wherein
the control signal is provided in response to a feedback signal of the lamp set by the control chip.
